(19) United States
(12) Patent Application Publication
(10) Pub. No.: US 2006/0063858 A1
(43) Pub. Date: Mar. 23, 2006

(54) Ink composition and color filter including the same

(75) Inventors: Yoon-Ho Kang, Gyeonggi-do (KR); Choon-Ho Park, Gyeonggi-do (KR); Kyung-Ah Kim, Incheon-si (KR); Gil-Lae Kim, Daejeon-si (KR); Chan-Seok Park, Gyenggi-do (KR); Seong-Gyu Kwon, Gyeonggi-do (KR); Jang-Sub Kim, Gyeonggi-do (KR); Byoung-Joo Kim, Gyeonggi-do (KR)

Correspondence Address: MacPherson Kwok;Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 11/229,271

(22) Filed: Sep. 15, 2005

(30) Foreign Application Priority Data
Sep. 15, 2004 (KR) 10-2004-0073790
Dec. 17, 2004 (KR) 10-2004-0108138

(51) Int. Cl. C03C 17/00; C09D 11/00

(52) U.S. Cl. 523/160; 523/161

(57) ABSTRACT

An ink composition comprising dipropylene glycol monomethyl ether acetate (DPMA). For example, an ink composition for a color filter includes a binder material, a monomer material, a polymerization initiator, a pigment dispersion, and a solvent including dipropylene glycol monomethyl ether acetate (DPMA).

### CROSS-REFERENCE TO RELATED APPLICATIONS

This application claims the benefit of Korean Patent Application No. 10-2004-0073790, filed on Sep. 15, 2004 in the Korean Intellectual Property Office, and Korean Patent Application No. 10-2004-0108138, filed on Dec. 17, 2004 in the Korean Intellectual Property Office, the disclosures of which are hereby incorporated herein by reference.

### BACKGROUND OF THE INVENTION

(a) Field of the Invention

The present invention relates to an ink composition for inkjet printing and color filter including the same.

(b) Description of the Related Art

A liquid crystal display (LCD) is a widely used flat panel display type.

An LCD generally includes a thin film transistor (TFT) array panel, a color filter panel having field-generating electrodes, and a liquid crystal layer disposed between the panels. The field generating electrodes are supplied with voltages to generate electric fields. The generated electric fields determine the orientations of liquid crystal molecules in the liquid crystal layer, thereby controlling the transmittance of light passing through the liquid crystal layer.

The color filter panel includes color filters representing primary colors such as red, green, and blue. The color filters are typically formed by conventional printing, electrodeposition, pigment dispersion, inkjet printing, or other technique.

The conventional printing technique coats red, green, and blue inks on a printing plate and prints the color filters. The conventional printing technique is limited in accuracy, and may not be suitable for large LCDs.

The electrodeposition technique forms the color filters using electroplating.

Although the color filters formed by electroplating have very flat surfaces, they generally have poor color characteristics, such as color concentration.

The pigment dispersion technique is the most commonly used, because of its excellent ability to form fine patterns. However, the manufacturing process for this technique is relatively complicated.

In the pigment dispersion technique, color filters are formed by coating, light-exposing, developing, and curing pigment compositions dispersed in photoresist. For example, in order to form red color filters, a pigment composition for forming red color filters is coated on a substrate, exposed to light, and developed to form red color filters. The red color filters are then cured. Green and blue color filters may be formed using a similar process incorporating appropriate pigment compositions. Although the pigment dispersion techniques have excellent precision and reproducibility, the manufacturing steps are complicated. That is, the steps of coating, light exposure, development, and curing are required for each of red, green, and blue pixels. Because of the length of the manufacturing line, and the number of process control factors to be controlled, the manufacturing productivity may be low. In addition, the thickness of the color filters may need to be large to satisfy the high color reproducibility requirements for monitors, TVs, etc., set for in the NTSC (National Television System Committee) system.

Ink-jet printing of color filters may reduce or eliminate some of these concerns. The ink-jet printing technique sprays liquid color ink onto a panel using an ink-jet head to simultaneously form red, green, and blue color filters. The ink-jet printing simplifies the manufacturing of the color filters to reduce the manufacturing cost.

There are two kinds of ink-jet printing: bubble jet printing and piezo printing. The bubble jet printing technique generates oxygen bubbles to be discharged by heating the ink using a heating plate. Bubble generation forces ink out a nozzle, to be deposited on a substrate. The piezo printing technique exerts pressure on the ink using ceramic piezoelectric elements, forcing ink out the nozzle. The piezo printing technique may be used with both aqueous ink and oily ink, while the bubble jet printing technique is used with aqueous ink.

However, the ink-jet printing may be problematic. For example, the ink jet mechanism may cause color spreading. Additionally, the spray may be non-uniform, so that desired results are not obtained. Further, a nozzle for spraying the ink may be contaminated, and become choked. In some circumstances, the above-described problems may be severe.

A photolithography process is used in forming color filters using the pigment dispersion technique. The photosensitive material of the color filters usually includes a binder containing a hydroxyl group (—OH) for dissolving portions that are not exposed to light.

Although the ink jet printing technique does not require a binder containing a hydroxyl group, it requires a stable spray of color ink.

### SUMMARY OF THE INVENTION

An ink composition for a color filter includes a curable binder, a crosslinking monomer, a polymerization initiator, a pigment dispersion, and a solvent including dipropylene glycol monomethyl ether acetate (DPMA).

### BRIEF DESCRIPTION OF THE DRAWINGS

The present invention will become more apparent by describing embodiments thereof in detail with reference to the accompanying drawing in which:

FIG. 1A is a photograph showing nozzles of an ink-jet head before the ink spray;

FIG. 1B is a photograph showing nozzles after an ink composition including DPMA according to an embodiment of the present invention is sprayed;

FIG. 1C a photograph showing nozzles after a conventional ink composition including PGMEA solvent is sprayed;

FIG. 2A shows photographs of printed inks according to an embodiment of the present invention after first, second, third, and fourth sprays;

FIG. 2B shows firstly printed ink and no printed ink after the first spray for a conventional ink composition;

FIG. 3A is a photograph of printed color filters using an ink composition according to an embodiment of the present invention;

FIG. 3B is a photograph of printed color filters using a conventional ink composition;

FIG. 4 is a sectional view of an LCD according to an embodiment of the present invention; and

FIGS. 5-10 are sectional views of a color filter panel in intermediate steps of a manufacturing method according to an embodiment of the present invention.

### DETAILED DESCRIPTION OF EMBODIMENTS

Systems and techniques described herein may allow for an accurate and reliable inkjet system using an ink composition. In some embodiments, the inkjet system may be used to print color filters on a color filter display to be included in a display such as an LCD display. An ink composition for a color filter includes a curable binder material, a crosslinking monomer material, a polymerization initiator, a pigment dispersion material, and a solvent including dipropylene glycol monomethyl ether acetate (DPMA).

The curable binder may include an acrylic polymer material, an oligomer material, or other binder material.

The curable binder may include at least one of: acrylic acid, methacrylic acid, itaconic acid, maleic acid, fumaric acid, 2-acryloyloxy ethyl hydrogen phthalate, 2-acryloyloxy propyl hydrogen phthalate, 2-acryloyloxy propyl hexahydrogen phthalate, isobutyl acrylate, t-butyl acrylate, lauryl acrylate, glycidyl acrylate, alkyl acrylate, cyclohexyl acrylate, isobornyl acrylate, benzyl acrylate, 2-hydroxy acrylate, 3-methoxybutyl acrylate, ethylcarbitol acrylate, phenoxyethyl acrylate, 4-hydroxybutyl acrylate, phenoxy polyethylene glycol acrylate, 2-hydroxyethyl acrylate, 2-hydroxypropyl acrylate, 2-hydroxy-3-phenoxy propyl acrylate and methacrylates thereof; acrylates including a halide such as 3-fluoroethyl acrylate and 4-fluoropropyl acrylate and methacrylates thereof; acrylates including a siloxyl group such as triethyl siloxyl ethyl acrylate and methacrylates thereof; and aromatic olefins such as styrene and 4-methoxystyrene.

In some embodiments, the content of the curable binder may be equal to about 5-20 wt %. When the curable binder is less than about 5 wt %, the adhesion with a substrate material may be poor and a film formed of the ink composition may have reduced film strength, reduced heat resistance, and/or reduced chemical resistance. On the contrary, when the curable binder is greater than about 20 wt %, the ink composition may have increased viscosity, which may decrease uniformity of the inkjet ejection from an inkjet head.

The crosslinking monomer material may include a thermosetting monomer that may require no light exposure. The ink composition may be cured at a temperature of about 220° C. after it is coated.

The crosslinking monomer material may include at least one of 1,4-butanediol diacrylate, 1,3-butylene glycol diacrylate, ethylene glycol diacrylate, pentaerythritol tetraacrylate, triethylene glycol diacrylate, polyethylene glycol diacrylate, di-penta erythritol diacrylate, sorbitol triacrylate, bisphenol A diacrylate derivative, trimethylpropane triacrylate, di-pentaerythritol polyacrylate, and methacrylates thereof.

The content of the crosslinking monomer material may be equal to about 0.5-5 wt %. An ink composition including less than 0.5 wt % crosslinking monomer material may have reduced curability and reduced insoluble fraction, which may make it difficult to obtain a desired thickness of a color filter. On the contrary, an ink composition including more than about 5 wt % crosslinking monomer material may have increased viscosity, which may decrease uniformity of the inkjet ejection from an inkjet head.

The polymerization initiator may include at least one of triazine-based compound, acetophenone-based compound, xanthone-based compound, benzoin-based compound, and imidazole-based compound. The polymerization initiator may include at least one of 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphthyl-6-triazine, benzophenone, p-(diethylamino)benzophenone, 2,2-dichloro-4-phenoxy acetophenone, 2,2-diethoxy acetophenone, 2,2-dibutoxy acetophenone, p-t-butyl trichloroacetophenone, 2-methyl thioxantone, 2-isobutyl thioxantone, 2-dodecyl thioxantone, 2,4-dimethyl thioxantone, 2,4-diethyl thioxantone, and 2,2-bis-2-chlorophenyl-4,5,4,5-tetraphenyl-2-1,2-biimidazole.

The content of the polymerization initiator may be about equal to or more than about 0.01 wt %, and preferably about 0.01-0.5 wt %.

The pigment dispersion material may include a pigment material and a dispersion medium. The pigment material may include at least one of an organic or inorganic pigment material.

Examples of organic pigment materials include C.I. (color index) Pigment Yellow 83, C.I. Pigment Yellow 150, C.I. Pigment Yellow 138, C.I. Pigment Yellow 128, C.I. Pigment Orange 43, C.I. Pigment Red 177, C.I. Pigment Red 202, C.I. Pigment Red 209, C.I. Pigment Red 254, C.I. Pigment Red 255, C.I. Pigment Green 7, C.I. Pigment Green 36, C.I. Pigment Blue 15, C.I. Pigment Blue 15:3, C.I. Pigment Blue 15:4, C.I. Pigment Blue 15:6, C.I. Pigment Violet 23, C.I. Pigment Black 1, and C.I. Pigment Black 7.

Examples of inorganic pigment materials include titanium dioxide, titanium black, and carbon black. Two or more pigments may be mixed for color combinations.

The content of the pigment dispersion material may be equal to about 30-70 wt %. An ink composition including less than about 30 wt % pigment dispersion material may not have a desired spectrum characteristic, while an ink composition including more than about 70 wt % pigment dispersion material may have reduced adhesion with a substrate and may not have a desired curing characteristic.

The DPMA in the solvent has a relatively high boiling point of about 205-210° C. as compared with a conventional solvent having a boiling point of about 140-170° C. Thus, a solvent material including DPMA may have a reduced volatility, which may in turn lead to reduced contamination of an inkjet head and a more uniform spray from the inkjet head. Since the DPMA exhibits a low viscosity at a use temperature, the inkjet head experiences reduced contamination. As a result, it repeatedly sprays without being choked, and draws patterns having excellent straightness. In addition, the DPMA exhibits good adhesion with a glass substrate and a black matrix, so that the resulting film does not come off

The solvent may further include one or more additional materials. The solvent may further include at least one of ethyl acetate, n-butyl acetate, isobutyl acetate, ethylene glycol monomethyl ether acetate, ethylene glycol n-butyl ether acetate, diethylene glycol dimethyl ether, diethylene glycol methyl ethyl ether, diethylene glycol ethyl ether acetate, dipropylene glycol, n-butyl ether, tripropylene glycol, n-propyl ether, tripropylene glycol methyl ether, propylene glycol methyl ether acetate, propylene glycol diacetate, propylene glycol monomethyl ether, propylene glycol monoethyl ether acetate, cyclohexanone, ethyl 3-methoxypropionate, methyl 3-ethoxypropionate, and ethyl 3-ethoxy propionate. More preferably, the solvent further includes ethylene glycol n-butyl ether acetate (EGBEA), propylene glycol diacetate (PGDA), diethylene glycol monoethyl ether (DPGME), and diethylene glycol monoethyl ether (Carbitol).

The content of the DPMA in the solvent may be equal to about 1-100 wt %, and preferably equal to about 40-100 wt %.

The content of the DPMA in the solvent may be selected considering the solubility, pigment dispersiveness, coating property, and viscosity of solvent. In particular, when the content of the DPMA is less than about 40 wt %, the viscosity of the solvent may increase so that the ink may not continue to spray without interruption.

The content of the solvent solution in the ink composition is preferably equal to about 10-50 wt %. When the solution content is less than about 10 wt % of the ink composition, it may be difficult to realize uniform spray. On the contrary, the solution more than 50 wt % in the composition may have reduced insoluble fraction, which may decrease the color saturation.

The ink composition may further include at least one of a dispersing agent for improving pigment dispersion, a coating agent for improving coating characteristics, or an adhesion enhancer for enhancing the adhesion with the substrate.

The dispersing agent may be selected from polyesteric material, polyurethanic material, polyacrylic material, etc. A coating agent may include additives for improving coating characteristics that may also have antifoaming properties. For example, the additives may include one or more surfactants including silicone surfactant and fluoro surfactant. The content of the dispersing agent, the coating agent, and the adhesion enhancer in the ink composition is preferably equal to about 0.01-1 wt %.

The ink composition preferably has suitable characteristics such as viscosity, flowability, antifoaming, flash point, pigment particles, etc., suitable for an ink-jet head, so that the ink composition sprayed from the ink-jet head is in a suitable form (e.g., has a suitable microscopic shape). A piezo ink-jet head employed in some embodiments of the present invention sprays ink droplets that may have a volume from about 10 pL to about 100 pL, and preferably from about 10 pL to about 30 pL. The graphic resolution is from about 100 to about 800 dpi (i.e., dots per inch), and preferably from about 400 dpi to 700 dpi.

The ink composition has a viscosity preferably from about 3 cP to about 50 cP, and more preferably about 7 cP to about 20 cP.

The pigment particles in the ink composition have a size preferably from about 50 nm to about 500 nm, and more preferably equal to or less than about 100 nm. Pigment particles larger than about 500 nm may decrease flowability to cause non-uniform spray, while pigment particles less than about 50 nm may decrease the stability of the dispersion.

Embodiments of the present invention now will be described more fully hereinafter, using a number of examples. The present invention may, however, be embodied in many different forms and should not be construed as limited to the embodiments set forth herein. The percentage and the mixture ratio in the following embodiments are based on weight.

### EXAMPLE 1

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 1). The curable binder included glycidyl methacrylate, benzyl methacrylate, and cyclohexyl methacrylate in monomer ratios of 40, 30, and 30, respectively, and had a weight average molecular weight equal to 15,000. The crosslinking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Green 36 having an average pigment diameter of 120 nm. The solvent was DPMA.

### EXAMPLE 2

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 2). The curable binder included glycidyl methacrylate, benzyl methacrylate, and cyclohexyl methacrylate in monomer ratios of 40, 30, and 30, respectively, and had a weight average molecular weight equal to 15,000. The crosslinking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Green 36 having an average pigment diameter of 120 nm. The solution included 40 wt % DPMA and 9.5 wt % tripropylene glycol methyl ether.

### EXAMPLE 3

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 3). The curable binder included glycidyl methacrylate, styrene, and cyclohexyl methacrylate in monomer ratios of 40, 30, and 30, respectively, and had a weight average molecular weight equal to 15,000. The crosslinking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Blue 15:6 having average pigment diameter of 90 nm. The solvent was DPMA.

### EXAMPLE 4

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 4). The curable binder included glycidyl methacrylate, benzyl methacrylate, and isobutyl methacrylate in monomer ratios of 40, 30, and 30, respectively, and had a weight average molecular weight equal to 15,000. The crosslinking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Red 254 having average pigment diameter of 110 nm. The solvent was DPMA.

### Comparative Example 1

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 5). The curable binder included glycidyl methacrylate, benzyl methacrylate, and cyclohexyl methacrylate in monomer ratios of 40, 30, and 30, respectively, and had a weight average molecular weight equal to 15,000. The crosslnking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Red 254 having an average pigment diameter of 110 nm. The solvent was propylene glycol monomethyl ether acetate.

### Comparative Example 2

A 5 wt % curable binder, a 5 wt % crosslinking monomer, a 0.5 wt % polymerization initiator, a 40 wt % pigment dispersion, and a 49.5 wt % solvent were used to fabricate a liquid phase composition (Composition 6). The curable binder included glycidyl methacrylate, benzyl methacrylate, and cyclohexyl methacrylate in monomer ratios of 40, 30, and 30, respectively, and had a weight average molecular weight equal to 15,000. The crosslinking monomer was a commercially available bisphenol A-based epoxy, EPIKOTE 1007, manufactured by Yuka Shell Epoxy Co. The polymerization initiator was a commercially available SI-L85 manufactured by Sanshin Chemical Industry Co., Ltd. The pigment dispersion was a 15% solution of C.I. Pigment Blur 15:6 having an average pigment diameter of 90 nm. The solvent was ethyl 3-ethoxy propionate.

### Embodiment 1

### Property Comparison

The contamination of a nozzle, the choking degree of the nozzle, and rectlinarity of patterns were estimated for the compositions including DPMA described in Examples 14 and the compositions without DPMA described in Comparative Examples 1 and 2.

A. Estimation of Contamination of Nozzle

Each of the ink compositions shown in Examples 1-4 and Comparative Examples 1 and 2 was sprayed over a 370 mm×470 mm substrate provided with a black matrix. The droplets had a volume of about 15 pL. After the spray, the ink-jet head was observed with a scanning electron microscope (SEM).

As shown in TABLE 1, the head was relatively clean for the compositions containing DPMA described in Examples 14, regardless of other ingredients in the composition. By contrast, the head was contaminated for the compositions described in Comparative Examples 1 or 2, which did not contain DPMA.

TABLE 1

| | | | | | Com- | Com- |
|---|---|---|---|---|---|---|
| Esti- | Exam- | Exam- | Exam- | Exam- | parative | parative |
| mation | ple 1 | ple 2 | ple 3 | ple 4 | Example 1 | Example 2 |
| Contami- | Low | Low | Low | Low | High | High |
| nation | | | | | | |

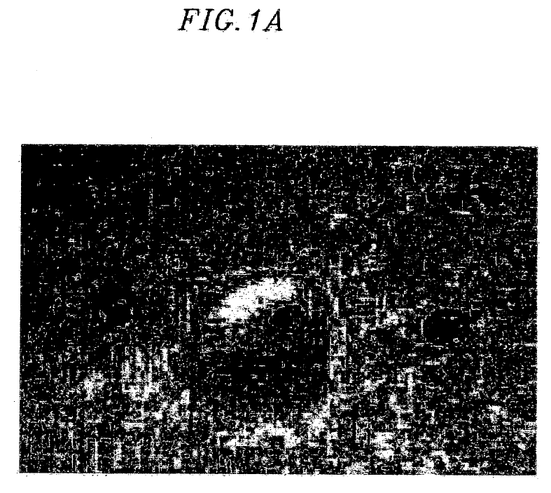

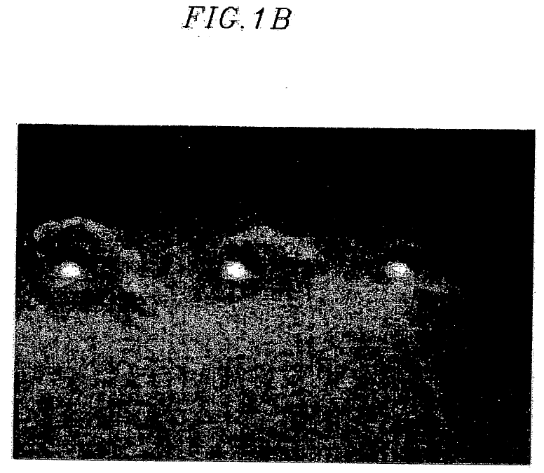

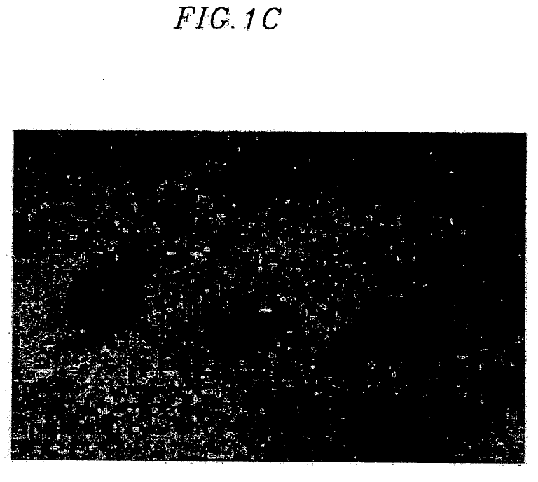

FIGS. 1A, 1B and 1C are SEM photographs for nozzles before and after the spray.

FIG. 1A shows nozzles of the ink-jet head before the ink spray, FIG. 1B shows the nozzles in a good state after the ink spray for Examples 1-4 with DPMA solvent, and FIG. 1C shows the nozzles in a contaminated state after the ink spray for Comparative Examples 1 and 2 with PGMEA solvent.

B. Estimation of Choking of Nozzle

On a photographic printing paper, each of the ink compositions shown in Examples and Comparative Examples was first sprayed, second sprayed five minutes after the first spray, third sprayed five minutes after the second spray, and fourth sprayed five minutes after the third spray. The droplets had a volume of about 15 pL. The printed ink was observed by naked eye.

TABLE 2 shows the result of the observation. Here, ∘ indicates “good,” □ indicates “partial printless,” and x indicates “printless.” As shown in TABLE 2, the first to the third spray was good for the compositions containing DPMA described in Examples 1-4, while the fourth spray was partially choked. However, the choking of the nozzles appeared after the first spray for the compositions described in Comparative Examples 1 or 2, which did not contain DPMA.

TABLE 2

| | Exam- | Exam- | Exam- | Exam- | Comparative | Comparative |
|---|---|---|---|---|---|---|
| Spray | ple 1 | ple 2 | ple 3 | ple 4 | Example 1 | Example 2 |
| 1st | ∘ | ∘ | ∘ | ∘ | ∘ | ∘ |
| 2nd | ∘ | ∘ | ∘ | ∘ | x | x |
| 3rd | ∘ | ∘ | ∘ | ∘ | — | — |
| 4th | □ | □ | □ | □ | — | — |

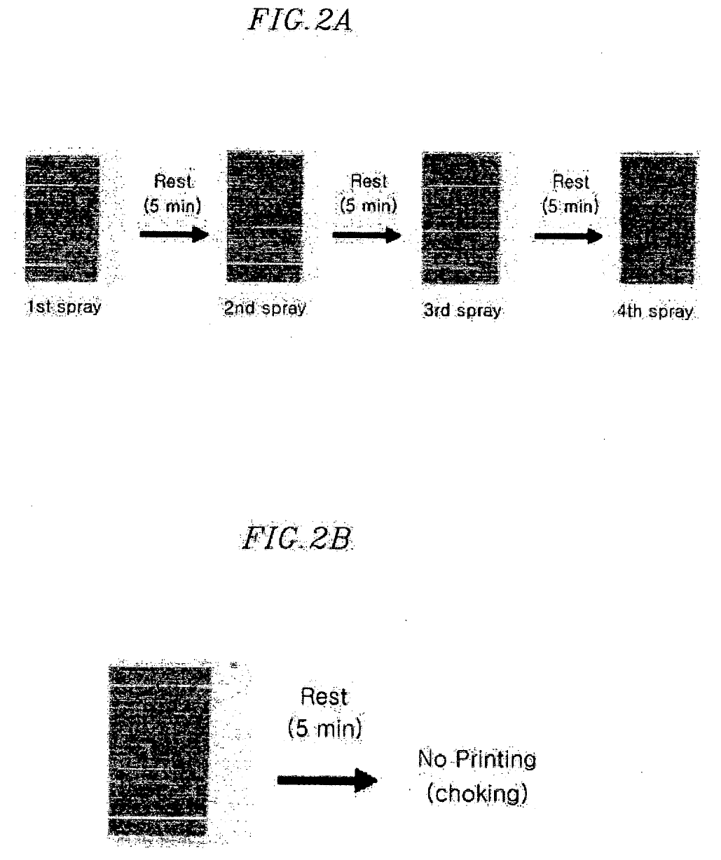

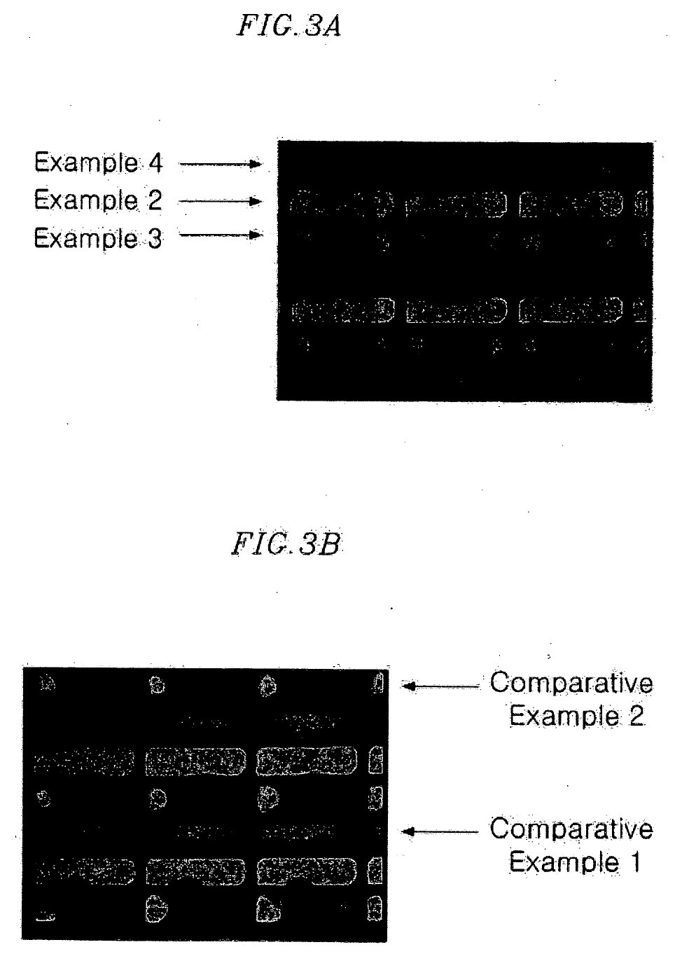

FIGS. 2A and 2B show photographs of printed inks.

FIG. 2A shows printed inks for Examples 14 after first, second, third, and fourth sprays, and FIG. 2B shows firstly printed ink and no printed ink after the first spray for Comparative Examples 1 and 2.

C. Estimation of Straightness of Printed Pattern

Each of the ink compositions described in Examples 2-4 and Comparative Examples 1 and 2 was sprayed over a 370 mm×470 mm substrate provided with a black matrix. The droplets had a volume of about 15 pL. After the spray, the printed pattern was observed with an optical microscope in order to estimate the straightness of the pattern.

TABLE 3 shows good straightness for the composition containing DPMA described in Examples 2-4 and poor straightness for the composition described in Comparative Examples 1 or 2, which does not contain DPMA.

TABLE 3

| | | | | Com- | Com- |
|---|---|---|---|---|---|
| | Example | Example | Example | parative | parative |
| Estimation | 2 | 3 | 4 | Example 1 | Example 2 |
| Straightness | Good | Good | Good | Poor | Poor |

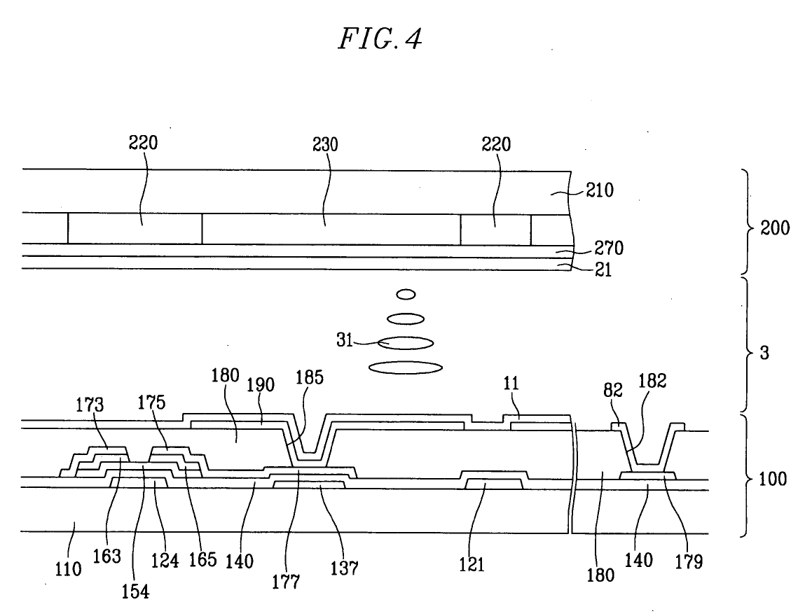

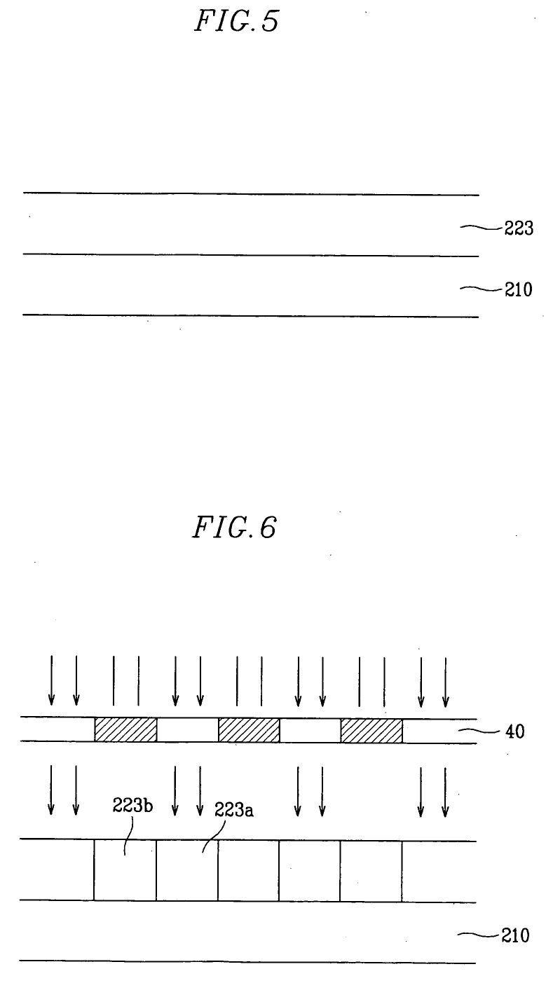

FIGS. 3A and 3B are photographs of printed color filters.

FIG. 3A shows that the patterns for Examples 24 exhibit excellent straightness and cleanness without color mixture, and FIG. 3B shows that the patterns for Comparative Examples 1 and 2 exhibit poor straightness and mixed colors.

### Embodiment 2

### Color Filter Panel Manufacturing

Now, color filter panels for liquid crystal display (LCD) including color filters made from an ink composition containing DPMA and manufacturing methods thereof are described in detail with reference to accompanying drawings.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

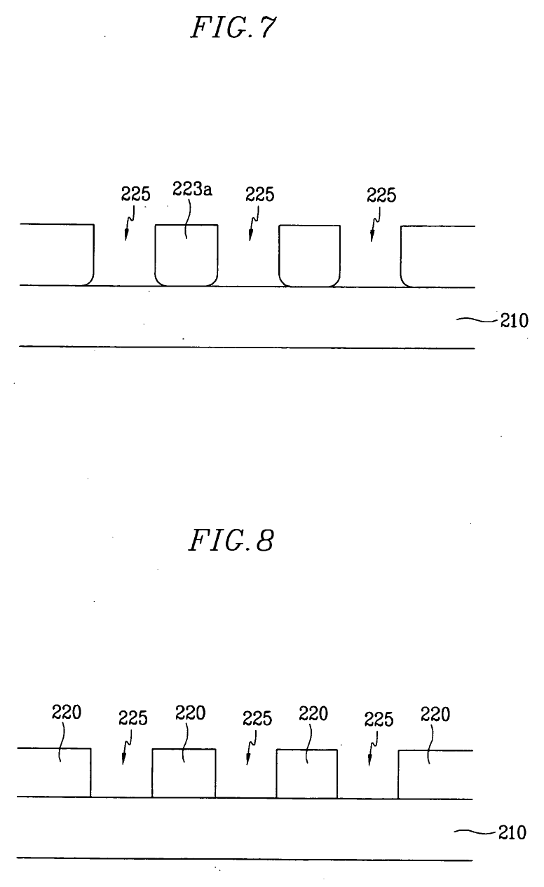

FIG. 4 is a sectional view of an LCD according to an embodiment of the present invention.

Referring to FIG. 4, an LCD according to an embodiment of the present invention includes a thin film transistor (TFT) array panel 100, a color filter panel 200 facing the TFT array panel 100, and a liquid crystal (LC) layer 3 disposed between the panels 100 and 200 and including LC molecules 31.

Regarding the TFT array panel 100, a plurality of gate lines 121 including gate electrode 124, and a plurality of storage electrodes 137 are formed on an insulating substrate 110. A gate insulating layer 140 is formed on the gate lines 121 and the storage electrodes 137, and a plurality of semiconductors 154 are formed on the gate insulating layer 140 opposite the gate electrodes 124. A plurality of pairs of ohmic contacts 163 and 165 are formed on the semiconductors 154, and each pair of ohmic contact 163 and 165 are disposed opposite each other.

A plurality of data lines (not shown) including source electrodes 173 and end portions 179, and a plurality of drain electrodes 175 including expansions 177 overlapping the storage electrodes 137 are formed on the ohmic contacts 163 and 165. A passivation layer 180 is formed on the source electrodes 173 and end portions 179 and the drain electrodes 175, and a plurality of contact holes 182 exposing the end portions 179 of the data lines and a plurality of contact holes 185 exposing the expansions 177 of the drain electrodes 175 are provided at the passivation layer 180.

A plurality of pixel electrodes 190 and a plurality of contact assistants 82 are formed on the passivation layer 180. The pixel electrodes 190 are connected to the drain electrodes 175 through the contact holes 185, and the contact assistants 82 are connected to the end portions 179 of the data lines through the contact holes 182.

Finally, an alignment layer 11 is coated on the pixel electrodes 190 and exposed portions of the passivation layer 180.

Regarding the color filter panel 200, a partition 220 is formed on an insulating substrate 210. The partition 220 is preferably made of negative photoresist and has a plurality of openings 225. The partition 220 may include a black color agent for substantially blocking light.

A plurality of color filters 230R, 230G and 230B are formed on the substrate 210 and disposed in openings 225, as described in FIGS. 7 and 8.

The partition 220 has a thickness of about 24 microns. When the thickness of the partition 220 is smaller than about two microns, the color filters 230R, 230G and 230B may not have a sufficient thickness. On the contrary, when the thickness of the partition 220 is larger than about four microns, the inclination angle of the sidewalls of the partition 220 may be decreased to cause afterimage and poor straightness.

A common electrode 270 is formed on the partition 220 and the color filters 230.

An overcoat (not shown) for providing a flat surface may be disposed between the common electrode 270 and the color filters 230 and the partitions 220.

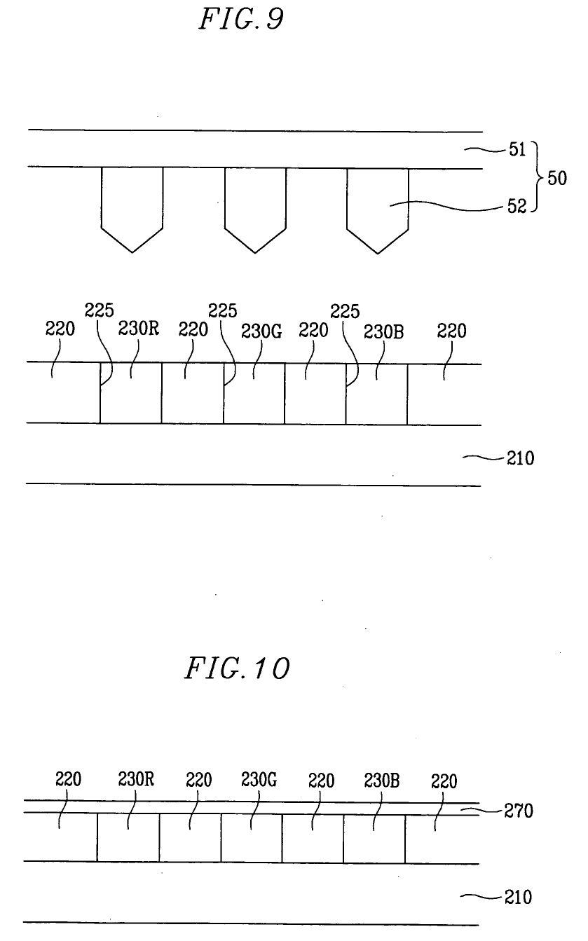

Now, a manufacturing method of the color filter panel 200 is described with reference to FIGS. 5-10.

Referring to FIG. 5, a negative photoresist film 223 having a thickness of about 2-4 microns is coated on a cleaned substrate 210. The photoresist film 223 may contain black pigment or black die.

Referring to FIG. 6, the photoresist film 223 is exposed to light having a wavelength of about 350-440 nm through a pattern mask 40. The photoresist film 223 is then post baked for about 90 seconds under a temperature of about 110° C. Portions 223a of the photoresist film 223 exposed to light will be remained after development, while portions 223b of the photoresist film 223 that are not exposed to light will be removed after development.

Referring to FIG. 7, the photoresist film 223 is developed with a developer of 2.38% TMAH such that the unexposed portions 223b are removed and the exposed portions 223a are remained, thereby forming a plurality of openings 225. The remaining portions 223a have a reversely-inclined edge profile as shown in FIG. 7.

Referring to FIG. 8, the photoresist pattern 223a is then heat-cured to be reflowed for about 180 seconds at a temperature of about 220° C. to form a partition 220 having vertical sidewalls defining the openings 225.

Referring to FIG. 9, a plurality of color filters 230R, 230G and 230B are formed in the openings 225 of the partition 220 by using an ink-jet printing device 50.

The ink-jet printing device 50 includes a main body (not shown), a printing head 51, and a plurality of nozzles 52. The nozzles 52 spray droplets of an ink composition in the openings 225 of the partition 220 in a controlled precision of the spray and a controlled amount of the sprayed composition.

The ink composition includes a curable binder, a crosslinking monomer, a polymerization initiator, a pigment dispersion, and a solvent including dipropylene glycol monomethyl ether acetate (DPMA).

The solvent may further include at least one of ethyl acetate, n-butyl acetate, isobutyl acetate, ethylene glycol monomethyl ether acetate, ethylene glycol n-butyl ether acetate, diethylene glycol dimethyl ether, diethylene glycol methyl ethyl ether, diethylene glycol ethyl ether acetate, dipropylene glycol, n-butyl ether, tripropylene glycol, n-propyl ether, tripropylene glycol methyl ether, propylene glycol methyl ether acetate, propylene glycol diacetate, propylene glycol monomethyl ether, propylene glycol monoethyl ether acetate, cyclohexanone, ethyl 3-methoxypropionate, methyl 3-ethoxypropionate, and ethyl 3-ethoxy propionate. Preferably, the solvent includes at least one of ethylene glycol n-butyl ether acetate (EGBEA), propylene glycol diacetate (PGDA), diethylene glycol monoethyl ether (DPGME), and diethylene glycol monoethyl ether (Carbitol).

The content of the DPMA in the solvent may be equal to about 1-100 wt %, and preferably equal to about 40-100 wt %. In particular, when the content of the DPMA is less than about 40 wt %, the viscosity of the solvent may increase to an extent that the spray will not continue without interruption.

Referring to FIG. 10, a common electrode 270 is formed on the partition 220 and the color filters 230R, 230G and 230B.

Finally, an alignment layer 21 is formed on the common electrode 270.

As described above, an ink composition including a solvent containing DPMA reduces the contamination of the printing head in piezo printing, and improves the dispersiveness of the pigment and the straightness of the printed patterns. The color filters formed by the ink composition show excellent color concentration and uniform pattern.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An ink composition comprising:
a curable binder material;
at least one monomer material;
a pigment dispersion material; and
a solvent including dipropylene glycol monomethyl ether acetate (DPMA).

2. The ink composition of claim 1, wherein the weight percentage of the curable binder material is equal to about 5-20 wt %, the weight percentage of the at least one monomer material is equal to about 0.5-5 wt %, the weight percentage of the pigment dispersion material is equal to about 30-70 wt %, and the weight percentage of the solvent is equal to about 10-50 wt %.

3. The ink composition of claim 1, wherein the weight percentage of the DPMA in the solvent is equal to about 1-100 wt %.

4. The ink composition of claim 3, wherein the weight percentage of the DPMA in the solvent is equal to about 40-100 wt %.

5. The ink composition of claim 1, wherein the solvent further comprises at least one of ethyl acetate, n-butyl acetate, isobutyl acetate, ethylene glycol monomethyl ether acetate, ethylene glycol n-butyl ether acetate, diethylene glycol dimethyl ether, diethylene glycol methyl ethyl ether, diethylene glycol ethyl ether acetate, dipropylene glycol, n-butyl ether, tripropylene glycol, n-propyl ether, tripropylene glycol methyl ether, propylene glycol methyl ether acetate, propylene glycol diacetate, propylene glycol monomethyl ether, propylene glycol monoethyl ether acetate, cyclohexanone, ethyl 3-methoxypropionate, methyl 3-ethoxypropionate, ethyl 3-ethoxy propionate, ethylene glycol n-butyl ether acetate, propylene glycol diacetate, diethylene glycol monoethyl ether, and diethylene glycol monoethyl ether.

6. The ink composition of claim 1, further comprising a polymerization initiator.

7. The ink composition of claim 1, wherein the curable binder material comprises acrylic polymer or oligomer or both.

8. The ink composition of claim 1, wherein the pigment dispersion material comprises pigment and a dispersion medium.

9. The ink composition of claim 8, wherein the pigment comprises at least one of organic pigment and inorganic pigment.

10. The ink composition of claim 8, wherein the pigment has an average particle size of about 50-500 nm and the ink composition has a viscosity of about 3-50 cP.

11. The ink composition of claim 1, further comprising a dispersing agent and a coating agent.

12. The ink composition of claim 11, wherein the dispersing agent comprises at least one of polyesteric material, polyurethanic material, and polyacrylic material.

13. The ink composition of claim 11, wherein the coating agent comprises at least one of a silicone surfactant and a fluoro surfactant.

14. A color filter panel comprising:
a substrate;
a plurality of color filters formed on the substrate; and
a common electrode formed on the color filters,
wherein the color filters are formed from an ink composition including a curable binder material, one or more monomer materials, a pigment dispersion material, and a solvent including dipropylene glycol monomethyl ether acetate (DPMA).

15. The color filter panel of claim 14, wherein the weight percentage of the curable binder material in the ink composition is equal to about 5-20 wt %, the weight percentage of the one or more monomer materials in the ink composition is equal to about 0.5-5 wt %, the weight percentage of the pigment dispersion material in the ink composition is equal to about 30-70 wt %, and the weight percentage of the solvent in the ink composition is equal to about 10-50 wt %.

16. The color filter panel of claim 14, wherein the solvent further comprises at least one of ethyl acetate, n-butyl acetate, isobutyl acetate, ethylene glycol monomethyl ether acetate, ethylene glycol n-butyl ether acetate, diethylene glycol dimethyl ether, diethylene glycol methyl ethyl ether, diethylene glycol ethyl ether acetate, dipropylene glycol, n-butyl ether, tripropylene glycol, n-propyl ether, tripropylene glycol methyl ether, propylene glycol methyl ether acetate, propylene glycol diacetate, propylene glycol monomethyl ether, propylene glycol monoethyl ether acetate, cyclohexanone, ethyl 3-methoxypropionate, methyl 3-ethoxypropionate, ethyl 3-ethoxy propionate, ethylene glycol n-butyl ether acetate, propylene glycol diacetate, diethylene glycol monoethyl ether, and diethylene glycol monoethyl ether.

17. An apparatus comprising:
an ink composition comprising:
a binder material;
at least one monomer material;
a pigment dispersion material; and
a solvent including dipropylene glycol monomethyl ether acetate (DPMA); and
an ink cartridge, wherein the ink composition is disposed within the ink cartridge, and wherein the ink cartridge includes mounting features to mount the ink cartridge to a printer.

18. The apparatus of claim 17, wherein the printer is an ink jet printer comprising a plurality of ink jet nozzles.

19. The apparatus of claim 18, further comprising the ink jet printer, and wherein the mounting features of the ink cartridge are engaged with complementary mounting features of the ink jet printer.

20. The apparatus of claim 19, wherein the ink jet printer is selected from the group comprising a piezo ink jet printer and a bubble ink jet printer.
